(19) United States
(12) Patent Application Publication
(10) Pub. No.: US 2003/0004276 A1
(43) Pub. Date: Jan. 2, 2003

(54) Polymer blends of polypropylene and ethylene-octene copolymers, method of blending, products made therefrom, and method of making products

(76) Inventor: George R Rowland JR., Houston, TX (US)

Correspondence Address: FINA TECHNOLOGY INC, PO BOX 674412, HOUSTON, TX, 77267-4412, US

(21) Appl. No.: 09/514,979

(22) Filed: Feb. 29, 2000

Related U.S. Application Data
(63) Continuation of application No. 08/941,577, filed on Sep. 30, 1997, now abandoned.

(51) Int. Cl. C08L 23/00

(52) U.S. Cl. 525/240

(57) ABSTRACT

A blend composition including from about 50 to about 99 weight percent polypropylene homopolymer and from about 50 to about 1 weight percent ethylene-C6+ α-olefin copolymer. A method of making the composition includes contacting the propylene homopolymer and the ethylene-C6+ α-olefin copolymer at a temperature above the melting point of the polymers, with useful articles formed therefrom.

### BACKGROUND OF THE INVENTION

1. Field of the Invention

The present invention relates to polymer blends, to methods of blending, to articles made from the blends, and to methods of making articles. In another aspect, the present invention relates to polymer blends of polypropylene and ethylene copolymers, to methods of blending polypropylene and ethylene copolymers, to articles made from blends of polypropylene and ethylene copolymers, and to methods of making articles from blends of polypropylene and ethylene copolymers. In even another aspect, the present invention relates to polymer blends of polypropylene and ethylene-C6+ α-olefin copolymers, to methods of blending polypropylene and ethylene-C6+ α-olefin copolymers, to articles made from blends of polypropylene and ethylene-C6+ α-olefin copolymers, and to methods of making articles from blends of polypropylene and ethylene-C6+ α-olefin copolymers. In still another aspect, the present invention relates to polymer blends of polypropylene and ethylene-octene copolymers, to methods of blending polypropylene and ethylene-octene copolymers, to articles made from blends of polypropylene and ethylene-octene copolymers, and to methods of making articles from blends of polypropylene and ethylene-octene copolymers.

2. Description of the Related Art

The commercially popular video cassette recorders (“VCR”) and video cameras utilize video tape wound on two spools residing inside a plastic case. This video tape case is generally provided with a paper sleeve which may display product indicia or a description of the tape contents.

A commonly utilized alternative to the paper sleeve is a polypropylene sleeve. These sheets are somewhat more expensive than paper sleeves, but have a longer useful life which economically justifies their use. These polypropylene sleeves are generally made by pressing fold marks into a cast propylene sheet, folding the sheet into a sleeve shape, and then ultrasonically welding the folded sheet into a sleeve.

Unfortunately, under certain operating conditions, namely cold ambient operating conditions, pressing fold marks into the cast propylene sheet will cause it to shatter.

The following are a sampling of the numerous patents which address the modification of polypropylene homopolymer with other polymers.

U.S. Pat. No. 4,386,187, issued May 31, 1983 to Grancio et al., discloses a thermoformable polymer blend composition comprising a styrene polymer, a crystalline olefin polymer such as polypropylene, and a block copolymer such as styrene-butadiene-styrene copolymer which acts as a compatibilizer for the olefin and styrene polymers in the blend. The composition may optionally include copolymers of monoolefins with other monoolefins.

U.S. Pat. No. 4,489,034, issued Dec. 18, 1984 to Davison, discloses a thermoforming process using a modified polymer blend. The polymer blend of polyethylene and crystalline isotactic polypropylene is modified by, for example, ethylene/propylene rubber, with the modifier present in the range of about 5 to about 35 weight percent.

U.S. Pat. No. 5,256,226, issued Oct. 26, 1993 to Marzola et al., discloses an adhesive polymer composition for repairing exposed or damaged parts of a plastic coating on metal tubing. The adhesive polymer composition is disclosed as including isotactic polypropylene and styrene-butadiene-styrene block copolymers.

U.S. Pat. No. 5,380,796, issued Jan. 10, 1995 to Campbell et al., discloses compositions of polyphenylene ethers and functionalized olefin polymers such as polyethylene. The composition can include impact modifiers, such as styrene-butadiene-styrene copolymers.

European Patent Application 0 060 524 A2, published Sep. 22, 1982, discloses a thermoplastic rubber consisting of a mixture of polypropylene, high-impact polystyrene and a styrene/diene block copolymer. The polypropylene is an isotactic polypropylene described as having an “isotacticity index of at least 80”. The amount of elastomeric styrene/diene block copolymer is disclosed as being between 30 and 90 weight percent.

However, in spite of these advancements in the prior art, there is need in the art for a replacement to the paper video cassette sleeve.

There is another need in the art for a plastic replacement to the polypropylene sheet that will not shatter during the pressing of fold lines into the sheet during the making of a video cassette sleeve.

This and other needs in the art will become apparent to those of skill in the art upon review of this specification, including its drawings and claims.

### SUMMARY OF THE INVENTION

It is an object of the present invention to provide for a replacement to the paper video cassette sleeve.

It is another object of the present invention to provide for a plastic replacement to the polypropylene sheet that will not shatter during the pressing of fold lines into the sheet during the making of a video cassette sleeve.

This and other objects of the present invention will become apparent to those of skill in the art upon review of this specification, including its drawings and claims.

According to one embodiment of the present invention, there is provided a composition comprising in the range of about 1 to about 99 weight percent polypropylene homopolymer, and in the range of about 99 to about 1 weight percent ethylene-C6+ α-olefin copolymer, based on the weight of the polypropylene homopolymer and ethylene-C6+ α-olefin copolymer. In a more preferred embodiment of this embodiment, the ethylene-C6+ α-olefin copolymer is an ethylene-octene copolymer.

According to another embodiment of the present invention, there is provided a method of making a polymer blend. The method generally includes contacting together polypropylene homopolymer and ethylene-C6+ α-olefin copolymer, at a temperature that is above the melting point of the each of the polymers, but below the point at which any substantial degradation of either polymer occurs. In a more preferred embodiment of this embodiment, the ethylene-C6+ α-olefin copolymer is an ethylene-octene copolymer.

According to even another embodiment of the present invention there is provided a method of forming an article. The method generally includes first contacting together polypropylene homopolymer and ethylene-C6+ α-olefin copolymer, at a temperature that is above the melting point of the polymers, but below the point at which any substantial degradation of either the polymers occurs, to form a mixture. This mixture is then formed into a desired shape, which is then cooled to below its melting point. In a more preferred embodiment of this embodiment, the ethylene-C6+ α-olefin copolymer is an ethylene-octene copolymer.

According still another embodiment of the present invention, there is provided an article comprising a formed body comprising in the range of about 1 to about 99 weight percent polypropylene homopolymer, and about 99 to about 1 weight percent ethylene-C6+ α-olefin copolymer, based on the weight of the polypropylene homopolymer and ethylene-C6+ α-olefin copolymer. In a more preferred embodiment of this embodiment, the ethylene-C6+ α-olefin copolymer is an ethylene-octene copolymer.

### DETAILED DESCRIPTION OF THE INVENTION

The blend compositions utilized in the practice of the present invention generally include isotactic polypropylene homopolymer and an ethylene-C6+ α-olefin copolymer. As used herein, a “C6+ α-olefin” is an αolefin having 6 or more carbon atoms. As also used herein, an “ethylene-C6+ α-olefin copolymer” is a copolyer of ethylene with an α-olefin having 6 or more carbon atoms.

The isotactic polypropylene homopolymer utilized in the blends of the present invention, and methods of making such polypropylenes, are well known to those of skill in the polyolefin art. An example of a suitable isotactic polypropylene homopolymer, methods of, and catalysts for its making can be found in U.S. Pat. Nos. 4,794,096 and 4,975,403, both herein incorporated by reference.

In general, the propylene homopolymers useful in the present invention may be obtained by polymerizing propylene in the presence of a Ziegler-Natta catalyst system which includes a transition metal compound cocatalyzed by an aluminum alkyl, or in the presence of a “Metallocene” catalyst system which includes a metallocene and a cocatalyst of aluminum alkyl or alumoxane.

In general, the particular homopolymer of polypropylene useful in the present invention will be selected according to the desired end use of the blend, for compatibility with the ethylene-C6+ α-olefin copolymer, and for compatibility with the blending and processing conditions.

Isotactic polypropylene suitable for use in the present invention will generally have a melt flow index which will allow the blends of the polypropylene and ethylene-C6+ α-olefin copolymer to be processed into video cassette tape sleeves. Generally, the isotactic polypropylene utilized in the present invention will have a melt flow index less than about 8. Preferably, the isotactic polypropylene utilized in the present invention will have a melt flow index less than about 7, more preferably less than about 6, and even more preferably less than about 5.0.

The polydispersity of the polypropylene homopolymer useful in the present invention will generally be in the range of about 2 to about 11, preferably in the range of about 5 to about 10, and more preferably in the range of about 5 to about 7.

The ethylene-C6+ α-olefin copolymer utilized in the present invention, and methods of making such an ethylene-C6+ α-olefin copolymer, are well known to those of skill in the polyolefin art. For example, numerous literature exists relating to polymerization of ethylene with higher order α-olefins, including U.S. Pat. Nos. 4,935,474 and 5,132,262, both herein incorporated by reference.

In general, the particular ethylene-C6+ α-olefin copolymer useful in the present invention will be selected according to the desired end use of the blend, for compatibility with the propylene homopolymer, and for compatibility with the blending and processing conditions for making the video cassette sleeve.

Of the ethylene-C6+ α-olefin copolymers, ethylene-hexene copolymers and ethylene-octene copolymers are preferred, with ethylene-octene copolymers being the most preferred.

In the practice of the present invention, the ethylene-C6+ α-olefin copolymer will generally comprise in the range of about 70 to about 99 weight percent ethylene and in the range of about 30 to about 1 weight percent C6+ α-olefin based on the total weight of the ethylene and C6+ α-olefin, preferably in the range of about 80 to about 99 weight percent ethylene and in the range of about 20 to about 1 weight percent C6+ α-olefin, and more preferably in the range of about 90 to about 99 weight percent ethylene and in the range of about 10 to about 1 weight percent C6+ α-olefin.

A nonlimiting example of a commercially available ethylene-C6+ α-olefin copolymer useful in the present invention includes an ethylene-octene copolymer available from Dow Chemical as grade 2247A.

The ethylene-C6+ α-olefin copolymer useful in the present invention is generally obtained by contacting the C6+ α-olefin and ethylene together under polymerization conditions and in the presence of a suitable Ziegler-Natta catalyst or metallocene catalyst systems.

Any suitable range of relative amounts of propylene homopolymer and ethylene-C6+ α-olefin copolymer may be utilized in the blends of the present invention provided that the blends may be processed into the desired video cassette sleeve. Generally, the blends of the present invention will comprise in the range of about 50 to about 99 weight percent polypropylene homopolymer, and in the range of about 50 to about 1 weight percent ethylene-C6+ α-olefin copolymer, based on the weight of propylene homopolymer and ethylene-C6+ α-olefin copolymer. Preferably, the blends of the present invention will comprise in the range of about 70 to about 99 weight percent polypropylene homopolymer, and in the range of about 30 to about 1 weight percent ethylene-C6+ α-olefin copolymer, based on the weight of propylene homopolymer and ethylene-C6+ α-olefin copolymer. More preferably, the blends of the present invention will comprise in the range of about 80 to about 99 weight percent polypropylene homopolymer, and in the range of about 20 to about 1 weight percent ethylene-C6+ α-olefin copolymer, and most preferably in the range of about 90 to about 99 weight percent polypropylene homopolymer, and in the range of about 10 to about 1 weight percent ethylene-C6+ α-olefin copolymer.

The blend compositions of the present invention may also contain conventional ingredients as are known to those of skill in the art. Non-limiting examples of such conventional ingredients include acid acceptors, antiblocking agents, antistatic agents, antioxidants, blowing agents, crystallization aids, dyes, flame retardants, fillers, impact modifiers, mold release agents, oils, other polymers, pigments, processing agents, reinforcing agents, slip agents, stabilizers, UV resistance agents, and the like.

Non-limiting examples of reinforcing agents include inorganic or organic products of high molecular weight, including glass fiber, asbestos, boron fibers, carbon and graphite fibers, whiskers, quartz and silica fibers, and synthetic organic fibers.

When such conventional ingredients are utilized, they will generally be present in a range from about 0.01 to about 50 weight percent of the total weight of the blend, preferably in a range from about 1 to about 25 weight percent of the total weight of the blend.

The blends of the present invention are generally made by contacting the polypropylene homopolymer and ethylene-C6+ α-olefin copolymer together at a temperature that is above the melting point of both the propylene homopolymer and ethylene-C6+ α-olefin copolymer, and below the point at which any substantial degradation occurs. The blend can then be directly shaped into useful articles, such as sheets for making the video cassette sleeves, or may be pelletized for later use.

Apparatus suitable for blending the present invention include but are not limited to an extruder, a Henschel blender or a Banbury mixer, solids blender, or drum tumbler.

The blends of the present invention may be shaped into products by any of the known thermoplastic forming techniques. Non-limiting examples of suitable techniques include injection molding, casting, extruding, pultruding, thermoforming, vacuum molding, stamping, forging, solid phase forming, rotary molding, and the like. The conditions for the various thermoplastic forming techniques, such as pressure, residence time, type of machinery, and the like, may be determined by one skilled in the art of forming thermoplastics.

### EXAMPLE

The following examples are provided to illustrate the present invention, and should not be taken as limiting the claimed invention in any way.

### Example

A blend composition is made from mixing homogeneous polypropylene with Grade 2247A Octene-LLDPE resin from Dow Chemical. The polypropylene and Grade 2247A Octene-LLDPE resin are added to a drum tumbler and allowed to tumble for 10 to 20 minutes. This tumbled material is then fed into an extruder and formed into sheets 0.17″ thick.

The formed sheets are cut into 36″×24″ sized sheets. Testing is accomplished by making 3 to 6 one inch cuts into the edge of the sheet, with the cuts oriented in the machine direction. The sheet is then hand torn at each of the cuts and the tearing observed. The tearing is categorized as being either straight line (not brittle) or zig-zag (brittle).

The above blend composition produced a straight line tear in the testing, indicating not brittle.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A composition comprising in the range of about 50 to about 99 weight percent polypropylene homopolymer, and in the range of about 50 to about 1 weight percent of a ethylene-C6+ α-olefin copolymer, based on the weight of the polypropylene homopolymer and ethylene-C6+ α-olefin copolymer.

2. The composition of claim 1 wherein the propylene is an isotactic polypropylene.

3. The composition of claim 2 comprising in the range of about 70 to about 99 weight percent polypropylene homopolymer, and in the range of about 30 to about 1 weight percent of a ethylene-C6+ α-olefin copolymer, and wherein the ethylene-C6+ α-olefin copolymer comprises in the range of about 70 to about 99 weight percent ethylene and in the range of about 30 to about 1 weight percent C6+ α-olefin.

4. The composition of claim 2 comprising in the range of about 80 to about 99 weight percent polypropylene homopolymer, and in the range of about 20 to about 1 weight percent of a ethylene-C6+ α-olefin copolymer, and wherein the ethylene-C6+ α-olefin copolymer comprises in the range of about 80 to about 99 weight percent ethylene and in the range of about 20 to about 1 weight percent C6+ α-olefin.

5. The composition of claim 2 comprising in the range of about 90 to about 99 weight percent polypropylene homopolymer, and in the range of about 10 to about 1 weight percent of a ethylene-C6+ α-olefin copolymer, and wherein the ethylene-C6+ α-olefin copolymer comprises in the range of about 90 to about 99 weight percent ethylene and in the range of about 10 to about 1 weight percent C6+ α-olefin.

6. The composition of claim 5 wherein the ethylene-C6+α-olefin copolymer is an ethylene-octene copolymer.

7. The composition of claim 2 wherein the ethylene-C6+α-olefin copolymer is an ethylene-octene copolymer.

8. A method of making a polymer blend comprising contacting together in the range of about 50 to about 99 weight percent polypropylene homopolymer, and in the range of about 50 to about 1 weight percent of a ethylene-C6+ α-olefin copolymer, based on the weight of the polypropylene homopolymer and ethylene-C6+ α-olefin copolymer.

9. The method of claim 8 wherein the propylene is an isotactic polypropylene.

10. The method of claim 9 comprising contacting together in the range of about 70 to about 99 weight percent polypropylene homopolymer, and in the range of about 30 to about 1 weight percent of a ethylene-C6+ α-olefin copolymer, wherein the ethylene-C6+ α-olefin copolymer comprises in the range of about 70 to about 99 weight percent ethylene and in the range of about 30 to about 1 weight percent C6+ α-olefin.

11. The method of claim 9 comprising contacting together in the range of about 80 to about 99 weight percent polypropylene homopolymer, and in the range of about 20 to about 1 weight percent of a ethylene-C6+ α-olefin copolymer, wherein the ethylene-C6+ α-olefin copolymer comprises in the range of about 80 to about 99 weight percent ethylene and in the range of about 20 to about 1 weight percent C6+ α-olefin.

12. The method of claim 9 comprising contacting in the range of about 90 to about 99 weight percent polypropylene homopolymer, and in the range of about 10 to about 1 weight percent of a ethylene-C6+ α-olefin copolymer, wherein the ethylene-C6+ α-olefin copolymer comprises in the range of about 90 to about 99 weight percent ethylene and in the range of about 10 to about 1 weight percent C6+ α-olefin.

13. The method of claim 12 wherein the ethylene-C6+ α-olefin copolymer is an ethylene-octene copolymer.

14. The method of claim 9 wherein the ethylene-C6+ α-olefin copolymer is an ethylene-octene copolymer.

15. An article comprising a formed body comprising in the range of about 50 to about 99 weight percent polypropylene homopolymer, and in the range of about 50 to about 1 weight percent of a ethylene-C6+ α-olefin copolymer, based on the weight of the polypropylene homopolymer and ethylene-C6+ α-olefin copolymer.

16. The article claim 15 wherein the propylene is an isotactic polypropylene.

17. The article of claim 16 comprising in the range of about 70 to about 99 weight percent polypropylene homopolymer, and in the range of about 30 to about 1 weight percent of a ethylene-C6+ α-olefin copolymer, and wherein the ethylene-C6+ α-olefin copolymer comprises in the range of about 70 to about 99 weight percent ethylene and in the range of about 30 to about 1 weight percent C6+ α-olefin.

18. The article of claim 16 comprising in the range of about 80 to about 99 weight percent polypropylene homopolymer, and in the range of about 20 to about 1 weight percent of a ethylene-C6+ α-olefin copolymer, and wherein the ethylene-C6+ α-olefin copolymer comprises in the range of about 80 to about 99 weight percent ethylene and in the range of about 20 to about 1 weight percent C6+ α-olefin.

19. The article of claim 16 comprising in the range of about 90 to about 99 weight percent polypropylene homopolymer, and in the range of about 10 to about 1 weight percent of a ethylene-C6+ α-olefin copolymer, and wherein the ethylene-C6+ α-olefin copolymer comprises in the range of about 90 to about 99 weight percent ethylene and in the range of about 10 to about 1 weight percent C6+ α-olefin.

20. The article of claim 19 wherein the ethylene-C6+ α-olefin copolymer is an ethylene-octene copolymer.

21. The article of claim 16 wherein the ethylene-C6+ α-olefin copolymer is an ethylene-octene copolymer.

22. A method of forming an article comprising:
(a) contacting together in the range of about 50 to about 99 weight percent polypropylene homopolymer, and in the range of about 50 to about 1 weight percent of a ethylene-C6+ α-olefin copolymer, based on the weight of the polypropylene homopolymer and ethylene-C6+ α-olefin copolymer;
(b) heating the mixture above the melting point of the mixture to form a heated mixture;
(c) forming the heated mixture into a desired shape; and,
(d) cooling the desired shape to below the melting point of the mixture.

23. The method of claim 22 wherein the propylene is an isotactic polypropylene.

24. The method of claim 23 wherein step (a) comprises contacting together in the range of about 70 to about 99 weight percent polypropylene homopolymer, and in the range of about 30 to about 1 weight percent of a ethylene-C6+ α-olefin copolymer, wherein the ethylene-C6+α-olefin copolymer comprises in the range of about 70 to about 99 weight percent ethylene and in the range of about 30 to about 1 weight percent C6+ α-olefin.

25. The method of claim 23 wherein step (a) comprises contacting together in the range of about 80 to about 99 weight percent polypropylene homopolymer, and in the
